(19) United States
(12) Patent Application Publication
(10) Pub. No.: US 2006/0015579 A1
(43) Pub. Date: Jan. 19, 2006

(54) Architecture and protocol for a wireless communication network to provide scalable web services to mobile access devices

(76) Inventors: Bharat Sastri, Pleasanton, CA (US); Shiv Balakrishnan, Saratoga, CA (US)

Correspondence Address: SAWYER LAW GROUP LLP, P O BOX 51418, PALO ALTO, CA, 94303, US

(21) Appl. No.: 10/892,975

(22) Filed: Jul. 16, 2004

(51) Int. Cl. G06F 15/16

(52) U.S. Cl. 709/219

(57) ABSTRACT

A network architecture for small, low-cost, high functionality portable wireless devices which shifts many of the functions performed in typical handheld communication devices to a central Application Server (AS) computer. Communication between the AS and the portable devices is performed using standard Internet Protocol (IP) devices. The AS includes a Client Proxy Server (CPS) which interfaces of applications on the server, and Device Personality Objects (DPOs) that handle the special characteristics of each different types of portable devices. Each portable device has a unique CPS/DPO pair running on the AS that accepts input from the portable devices and provides input to the various applications on the AS and which accepts outputs from the various applications and passes it to the portable devices. Communication from the portable devices to the AS is entirely via IP packets.

### FIELD OF THE INVENTION

The present invention relates to communications and more particularly wireless communication systems.

### BACKGROUND OF THE INVENTION

The functionality) of cellular telephones and other hand-held communication devices has been increasing rapidly. Internet enabled cellular telephones and personal digital assistants (PDAs) that can communicate via the Internet are now in widespread use.

A variety of digital communication protocols have been developed. A number of non-compatible communication protocols and air interfaces such as PDC/PHS, TDMA, CDMA, GSM and IEEE802.11x have been deployed in the market. However no protocol is ubiquitous. In fact many communication systems incorporate one or more of these protocols to deliver services to their customers.

Third generation wireless protocols that handle voice, video and data are being developed. The third generation protocols are designed to handle voice, video and data communication over devices such as cellular telephones, PDAs, and laptop computers.

A typical handheld communication device (e.g. cellular phone or PDA) is relatively complex. Almost all hand-held communication devices include a keypad/keyboard and also include a display device (of varying resolution), which may in many cases be a touch-screen. The technical complexities of these handheld devices make them relatively expensive. In order to encourage widespread usage of such communication devices, some network service providers subsidize the cost of these hand-held communication devices.

Additionally because the difference in the feature sets and processing power available in these communication devices, there is no efficient and low cost method to deliver standard content to all devices. A number of attempts such as Wireless Application Protocol have been created. WAP requires the execution of a browser on the cellular phone or PDAs. This browser then makes custom requests to the target web applications. The web application also needs to be modified to format the content to match the capabilities of the hand-held device in use. Rewriting and reformatting of content is an impediment to the deployment of a variety of applications to customers. The requirement to execute a browser on the hand-held device generally requires a processor, large memory, a display etc. adding cost to the device. It also results in relatively large power consumption leading to relatively short battery life.

The architecture for a typical prior art hand-held mobile device is shown in FIG. 1. The components of a typical prior art hand-held device include a microprocessor 185 and associated RAM and Flash memory 184. The microprocessor 185 executes the resident software and controls the input/output devices. The input/output devices include devices such as microphone/speaker 183, keypad/board 181, display device 182, a codec 186, a radio transceiver 189 and often a DSP 187 for signal processing. In view of the number of components and the complexity, prior art hand-held devices are relatively expensive and they use a relatively large amount of power.

The present invention is directed to a system and method which will accommodate relatively low cost hand-held devices that use relatively small amount of power.

### SUMMARY OF THE PRESENT INVENTION

The present invention provides a system that can accommodate very simple low cost portable (i.e. hand-held) devices that use very small amount of power. The system includes a central server that runs a variety of applications and which has a software module associated with each portable device. Each portable device communicates with its associated software module using wireless communication and the well known Internet Protocol (IP) that has been developed for the internet. With the present invention the portable merely sends and receives IP packets. The portable device does not include a browser.

The present invention provides an Internet Protocol based system and method that may be implemented over a heterogeneous wireless communication network. A system operating in accordance with the present invention includes:
1. A set of hardware components that enable radio communication and IP packetization. The software includes a Software Defined Radio (SDR) and Application Specific Device (ASD) modules.
2. Matching software protocol programs: The system includes a Client Proxy Server (CPS) and a Device Personality Object (DPO) program pair that executes at an Application Server (AS). The CPS/DPO program pair abstracts all the device dependencies from the application and uniquely maps the mobile access device to the target application. The CPS/DPO program pair contains all of the information required to map content and translate requests to and from the application and to the accessing mobile devices. There is a unique CPS/DPO program pair for each mobile device that is active.

Data is exchanged between hand-held communication devices and cellular wireless base stations using IP data packets. All devices can use this IP packet transmission protocol to allow for frequency sharing and compatibility with existing internet infrastructure.

The system can include very small, very low power hand-held devices, that do not include a dial/key-pad, large data storage or a complex microprocessor based platform and can be low cost and low power devices.

Each hand-held device is logged into the Internet via a base station and results in the spawning of a CPS/DPO program pair at the Application Server (AS) where the target application resides. CPS establishes a session for each remote wireless device. A single CPS can have multiple DPOs, each DPO being a plug-in software object. The DPO is responsible for translating the device requests to the application in use and also for translating the application responses to the appropriate format required by the requesting mobile device. A very small footprint or “lightweight” software component is embedded in each hand-held device and is responsible for the IP packet management.

The Application Server is typically a large computer with enormous power. By executing this complex code i.e. the CPS/DPO combination, at the Application Server it is possible to provide rich applications to simple, low-cost mobile or hand-held devices. The cost of complex microprocessor based devices may be dispensed with. This enables the manufacture and deployment of very low-cost wireless hand-held devices for internet access. The computational capability at the AS is generally capable of handling thousands of such CPS/DPO sessions in parallel enabling a practical way to deploy services.

This method also enables the rapid deployment of applications by simply deploying the appropriate DPO for a particular mobile device class at the “head end” of the network i.e. at the AS. This ability to harness the computing power of the Application Server also results in better security, customer experience etc.

### BRIEF DESCRIPTION OF THE DRAWINGS

FIG. 1 shows the components in a typical prior art hand-held communication device.

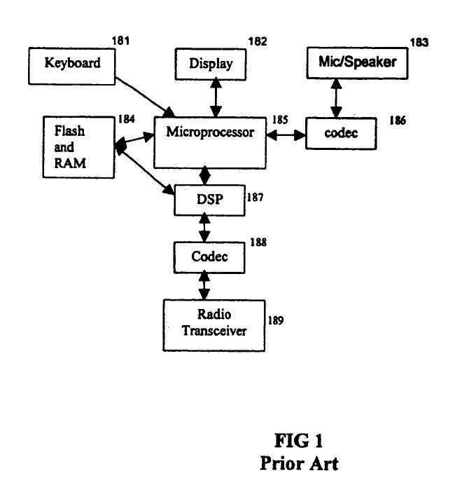

FIG. 2 is an overall diagram that shows an IP based wireless/mobile network.

FIG. 3 is a diagram of a typical protocol stack required to implement an IS-95 cdma or CDMA2000 wireless network.

FIG. 4 is a diagram of the hardware components that separate the radio transceiver from the application specific device interface.

FIG. 5 shows the minimum set of components that remain in a simplified low-cost hand-held communication device with the present invention.

FIG. 6 shows a more general implementation of the present invention to interface multiple types of hand-held or mobile devices e.g. a PDA or a Notebook computer.

FIG. 7 is a diagram that shows the Software Hierarchy at the Application Server. It shows the CPS/DPO components that are required to realize the present invention.

FIG. 8 is a diagram that shows the typical handshake between the mobile device and the target Application Server including the execution of the Client Proxy Server

(CPS) program at the Application Server (AS) and ensuing application session.

FIG. 9 is a block diagram showing an example of the operations performed.

### DETAILED DESCRIPTION

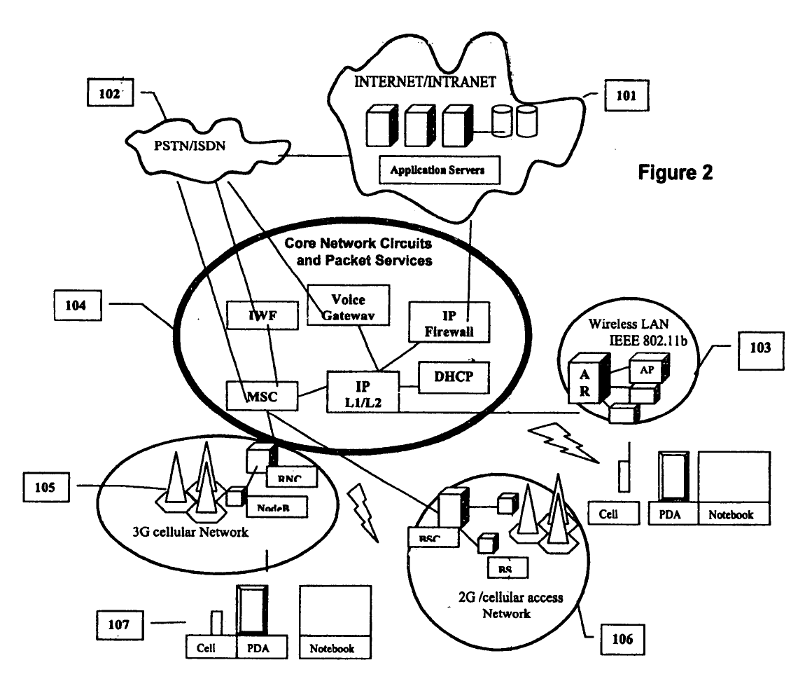

An overall diagram of the preferred embodiment of the present invention is shown in FIG. 2. The architecture of the system shown in FIG. 2 provides an all-IP wireless/mobile network. The present invention provides a network architecture, an application protocol and devices for small, low-cost, high functionality wireless communications. The present invention shifts many of the functions performed in a typical hand-held communication device to a powerful Application Server (AS) computer 101 via a connection with a wireless Base Station/Controller thru a Message Switching Center 104. The hand-held device communicates with the AS using IP packets; however, the portable device may not include a browser. The handheld device merely packetizes the inputs and sends it to the AS. The AS processes the information, executes the appropriate application program and sends packets back to the hand-held device. At the hand-held device the data stream from the as is de-packetized and provided to the user.

The various components of the system shown in FIG. 2 will now be described. The main components of the system are a number of Applications Servers (AS) 101 connected via a conventional internet of intranet networks, a group of Core Network circuits and packet services 104, and cellular access networks 105 and 106.

The system includes one or more instances of an IEEE802.11b/a/g Wireless LAN 103, a 2G cellular access network 106, a 3G cellular access network 105, the core network Circuit and Packet services infrastructure 104, a PSTN/ISDN network 102, an Internet/intranet cloud of servers 101. Also shown is a set of ubiquitous mobile/wireless devices e.g. a cell phone, a PDA, a Notebook computer 107.

The IEEE802.11b/a/g Wireless LAN 103 provides Access Points (AP in block 103) and Access Routers (AR in block 103) connectivity to the core services network 104.

The 2G cellular access network 106 has antennas, base stations and base station controllers in place. The cellular devices 107 connect to the Base Station (BS in block 106) and multiple base stations are controlled by a Base Station Controller (BSC in block 106). Multiple BSCs are then connected to the Message Switching Center (MSC in block 104) in the core services network 104.

Each of the outer access networks 103,105,106,102,101 is serviced by a network infrastructure 104, that provides core network circuit and packet switching services such as Message Switching Center (MSC in block 104), IP Layers 1 & 2 (IP L1/L2 in block 104), DHCP services (DHCP in block 104), Voice Gateway (Voice gateway in block 104), IP Fire-wall (IP Firewall in block 104).

Any of the mobile devices 107, have the ability to connect to any of the wireless access networks 105,103 or 106 to access any resources available on the network including the Application Server 101. The exact wireless protocol used to make a unique connection is unique when connecting to the wireless networks 103,105 106 shown.

With the present invention, all the heavy-duty computation and data storage is performed by the various blocks in the network from the Base Stations (BS in 106, FIG. 2) through the Application Servers 101 shown in FIG. 2. A user has access to functions such as e-mail, voice-mail, calendars etc via voice commands that are recognized and executed at the appropriate remote Application Server (101, FIG. 2) as opposed to on the mobile device. Also no local data storage is required on the mobile device. A user can store their entire contact database at the remote Application Server. This enables the mobile access device to become a simple low-cost, low-power device. It will be clear to those skilled in the art that the mobile device could be any other data/voice device such as a PDA or Notebook computer. Various types of devices can be connected. Each device has an Application Specific Device (ASD) type. A particular bit pattern generated by the ASD module indicates the device type or device class. This is used to deploy the appropriate software components in the Application Server.

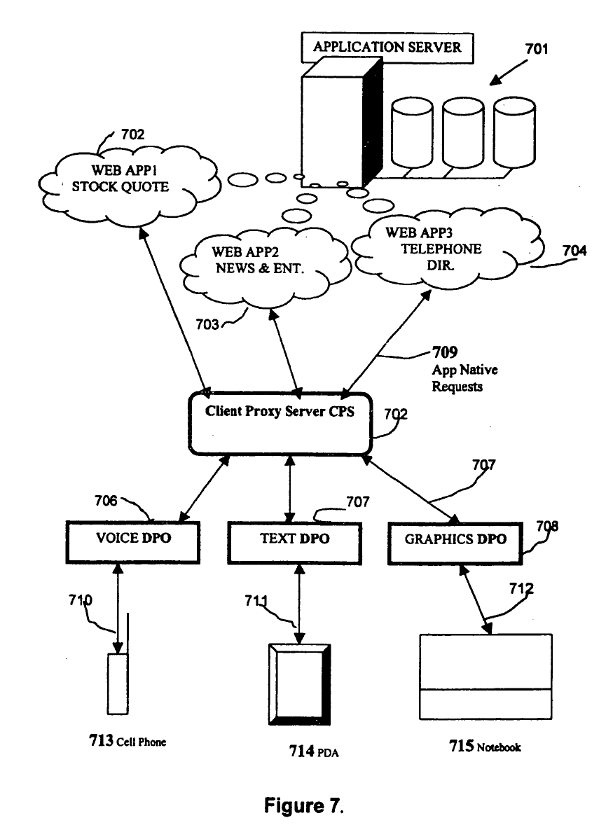

FIG. 7 shows the environment executing at the Application Servers (101, FIG. 2) resource. In this diagram the Application Server 701 is a powerful computing and data storage resource available to any device connected to the Internet. The diagram shows three native web Applications e.g. Web App1—Stock Quote 702, Web App2—News 703, Web App3—Telephone Directory 704. Also shown are three ubiquitous mobile devices—a cell phone 713, a PDA 714 and a notebook computer 715 that are accessing the web applications 702,703,704 at the Application Server 701. Each Application Server 701 has a program called the Client Proxy Server 705. The Client Proxy Server 705 is part of the present invention and is responsible for managing the application sessions for each connected mobile access device. It creates logical connection channels for the client device. An important aspect of this invention is the ability of any mobile device to connect to any Internet application and be serviced in a graceful scaleable manner. The present invention accomplishes this by implementing a set of programs called Device Personality Objects (DPOs), that abstract all the device dependencies from the target application. These DPOs can be defined to service various classes of mobile devices. Examples of such classes and the associated mobile access devices are: Voice only DPO—(e.g. telephone) 706, Text DPO—(e.g. pager/phone or PDA+phone) 707, Graphics DPO (e.g. PDA or Notebook computer) 708 but not limited to these.

Service or application requests from the access devices are routed to the appropriate DPO 706,707,708 at the Application Server 701. The appropriate DPO 706,707,708 then translates the mobile access device dependencies and creates a payload for the target web application 702,703,704 and sends it to the Client Proxy Server 705. The CPS 705 manages the order of requests and ensures the coherency of the message stream.

When the web application 702,703,704 responds to a request, the CPS 705 routes the payload to the correct DPO 706,707,708. The appropriate DPO then translates the payload into a format that is compatible with the target mobile requesting device 713,714,715. If the requestor is a Voice-Only device the Voice-Only DPO 706 will translate the application response into a voice or audio stream 710. This audio stream 710 is easily understood at the cell phone 713 which is an example of a Voice-only device.

The value of this approach is that any new set of devices with reicher functionality may be supported by simply writing and deploying the required DPO 706,707,708 for that class of devices at the Application Server. These DPOs may also be deployed at various nodes in the network e.g. at Base Stations if needed by a particular application.

The benefit derived from this architecture and method is that existing Internet or web applications can be made available to very low-cost devices in a useful manner without having to reformat the application or its content for each specific device. It eliminates the need for creation of one-off protocols such as Wireless Application Protocol (WAP) for cellular phones. This custom WAP browser makes specially formatted requests to a WAP customized application that has to manage custom content for each different WAP device. The drawback of the WAP approach is the high minimum capability required of the mobile device. In general the WAP system the mobile device needs to have a powerful microprocessor, a display, a key-pad etc. all of which makes it a relatively high cost device.

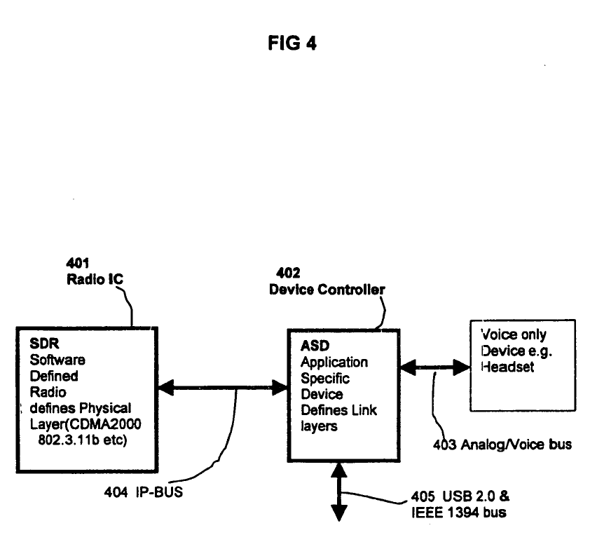

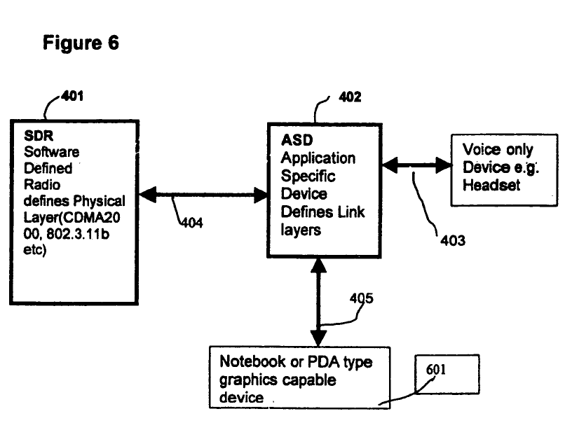

As shown in FIG. 4 and FIG. 6 the invention embodies multiple standards compatible Software Defined radio (SDR) 401 with a universal interface (IP-BUS) 404 for connecting mobile devices. The invention also includes an Application Specific Device (ASD) 402 component that provides standard interfaces. As shown in FIG. 6, the ASD 402 has a USB 2.0 or IEEE1394 bus at one end and the IP-BUS at the other end. Devices such as a notebook computer or a PDA 601 connect to the ASD via the USB 2.0 or IEEE1394 bus as shown in FIG. 6. The ASD also contains the logic to support packetization and de-packetization of IP data packets. The combination of SDR and ASD is all that is required to implement low-cost mobile devices. It is noted that software defined radios are known in the art. For example see: Gang Wu & Mitsuhiko Mizuno, Comm. Research lab, Japan; Paul J. M Having a, Univ. of Twente—“MIRAI—Architecture for a Heterogeneous Network” IEEE Communication Magazine, February 2002. The content of this reference is hereby incorporated herein by reference.

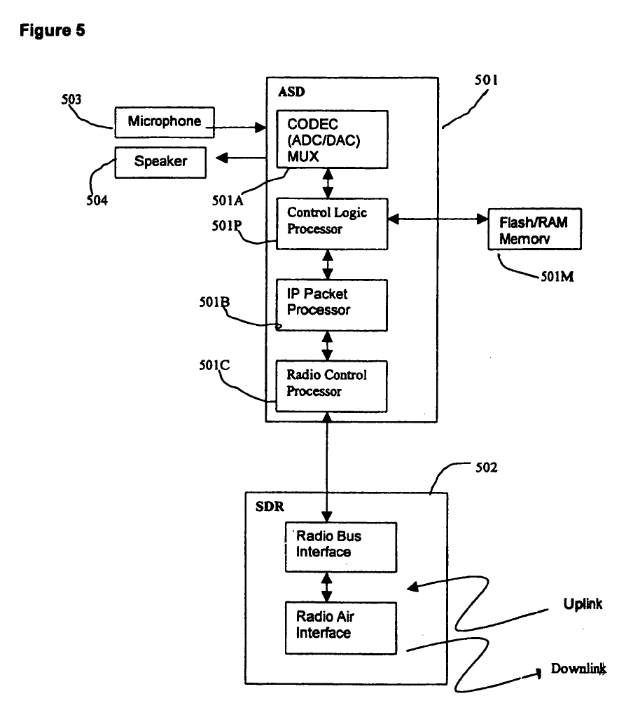

An example of a specific portable device constructed in accordance with the present invention is shown in FIG. 5. The device includes an Application Specific Device (ASD) 501 and a Software Defined Radio (SDR) 502. The radio transceiver SDR 502 is programmable to use standard wireless signaling methods e.g. IS-95 cdma or CDMA 2000 or IEEE 802.11a/b/g Wireless LAN mechanisms to communicate to the nearest base station or access point. The radio may be programmed to adapt to the available air/radio interface. The SDR 502 includes a conventional Radio Bus Interface and a conventional Radio Air Interface.

With the present invention the hand-held/mobile device need not include a keyboard or a display. For instance in the case of a voice/telephony only Application, the input and output from the hand-held device is audio data in the form of IP packets.

FIG. 5 illustrates an ASD that include a codec 501A to digitize the audio a packetizer 501B and a radio control processor block 501C to program the SDR into the appropriate mode. The entire device is controlled by Control Logic processor 501P that performs a conventional control program stored in Flash memory 501M.

With the present invention all the heavy-duty computation and data storage is performed by the various blocks in the network from the Base Station through the Application Servers shown in FIG. 2. A user has access to functions such as e-mail, voice-mail, calendars, etc. via voice commands that are recognized and executed at the appropriate remote Application Server as opposed to on the mobile device. Also no local data storage is required on the mobile device. A user can store their entire contact database at the remote Application Server. This enables the mobile device to become a simple low-cost, low-power device. It will be clear to those skilled in the art that the mobile device could be any other data/voice device such as a PDA or a notebook computer. Various types of devices can be connected. A particular bit pattern generated by the ASD indicates the device type or device class. This is used to deploy the appropriate software components in the Application Server.

An important aspect of this invention is the ability of any mobile device to connect to any Internet application and be serviced in a graceful scalable manner. This is accomplished by implementing a set of programs called Device Personality Objects (DPOs) that abstract all the device dependencies from the target application. These DPOs can be defined to service various classes of mobile devices. Examples of classes of devices are: “Voice-Only” e.g. Telephone, “Text-Only e.g. pager”, “Voice and Data e.g. PDA+phone”, “Graphics & Audio e.g. PDA or Notebook computer”, but not limited to these. The value of this approach is that any new set of devices with richer functionality may be supported by simply writing and deploying the required DPO program for that class of devices, at the Application Server. These DPOs may also be deployed at the various nodes in the networks e.g. at Base Stations if needed by a particular application.

The great benefit derived from this architecture and method is that existing Internet or web applications can be made available to very low-cost devices in a useful manner without having to reformat the application or its content for each specific device. It eliminates the need for creation of one-off protocols such as Wireless Application Protocol (WAP) for cellular phones. This custom WAP browser makes specially formatted requests to a WAP customized application that has to manage custom content for each different WAP device. The drawback of the WAP approach is the high minimum capability required of the mobile device. In general the WAP system the mobile device needs to have a powerful microprocessor, a display, a key-pad etc. all of which makes it a relatively high cost device.

The present invention takes advantage of the existing and robust IP packet data network and enables unique applications such as “Voice based Multi-party Instant Messaging” which would not be possible using current point-to-point methodology required by existing wireless communication systems.

The present invention allows mobile devices to communicate with the nearest base station or wireless access-point. The local connection is established using DHCP protocol. Also the Mobile IP standard is utilized to maintain a pair of IP addresses per mobile device i.e a “home IP address” and a “care-of IP address”. These support IP based mobility of the device when needed.

Since these connections are based on an IP data packet protocol, it enables all such devices within a cell to multiplex the air interface and use the bandwidth more efficiently. It also enables all the devices within that cell to message each other using standard IP messaging applications such as Instant messaging in an efficient manner with the base station acting as the router. If the DPOs are deployed on a Base Station, it will enable heterogeneous devices to communicate in a localized network thereby improving latency and performance.

The application architecture is an overlay on top of TCP/IP and abstracts the existing Link and Physical Layer infrastructure available. This structure may be IS-95 cdma or CDMA 2000, EDGE or IEEE 802.11a/b/g standard which uses digital packet data for both voice (Voice over IP or VOIP) and data transmission.

The value that this application protocol provides is that it enables existing IP based web applications to support multiple end-user mobile/wireless devices in a scaleable device specific manner without re-writing the application.

Hence a very simple “Voice Only” telephony device may be used to access voice and data services. This simple device has no keyboard or display and can therefore be very low cost. In its most basic form it is simply a voice driven mobile access device.

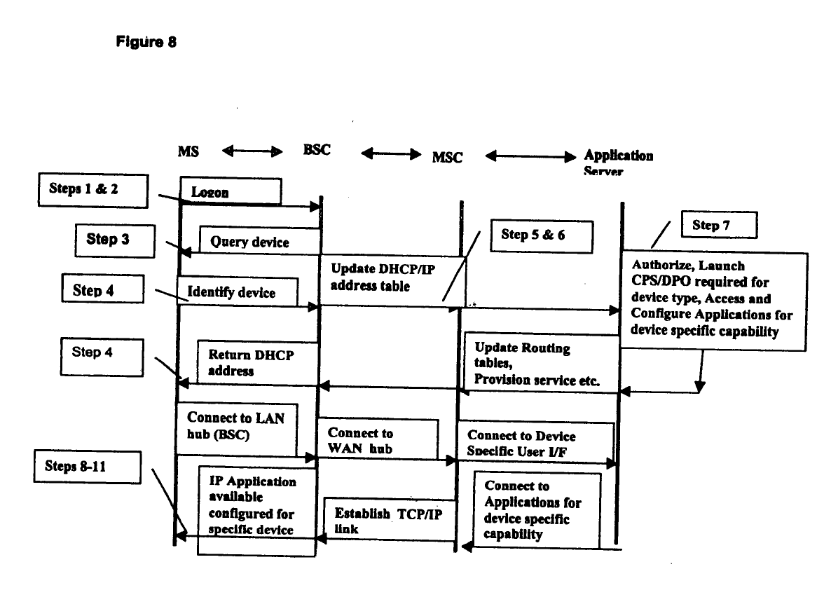

The steps performed during the operation of the present invention are illustrated in FIG. 8.

### EXAMPLE 1

### A Voice/Telephony Application using VoIP

A user has a minimal mobile device incorporating an Application Specific Device (ASD) and a Software Defined Radio (SDR) transceiver connected to a headset with a custom controller (see FIG. 5). This user can avail of web applications in the following manner: (as shown in FIG. 8)

Step 1. The user turns on the device and thus its radio transceiver.

Step 2. The radio establishes contact with the nearest Base Station using the appropriate air interface e.g. the available RF protocol and requests a network connection.

Step 3. The Base Station queries the device for its “Device Type”

Step 4. The device identifies itself as a “Voice Only” class mobile device. The Base Station passes the request to the Base Station Controller. (BSC)

Step 5. The Base Station Controller (BSC) proceeds to issue a DHCP address to the device and also informs the Message Switching Center (MSC) about the device and its associated DHCP generated DHCP “Care-of IP address”.

Step 6. The MSC performs the authorization, creates the IP address pair of the “Home IP address” and the “Care-of IP address” required to map the mobile device into its routing tables. It then connects the Application Server and invokes the appropriate Client Proxy Server (CPS)/Device Personality Object (DPO) program pair for the specific device (in this case, a “Voice Only” device). It then sends an acknowledgement to the MSC. The MSC then updates its internal mapping and routing tables and returns a valid DHCP address to the terminal mobile device. This completes the TCP/IP network link.

Step 7. The Application executing on the Application Server (AS) then queries the “Voice Only” device via the appropriate Client Proxy Server/DPO program pair that in this case would support voice recognition and synthesis as its user interface. The appropriate Application Server would then respond with “What would you like to do?” audio response

Step 8. The user says “I want to make a call”. This is voice input is packetized and transmitted to the AS where the CPS, a voice recognition module in this case, translates this voice request into Application program commands.

Step 9. The application asks “Who should I call?”. This response is sent back from the application as a digital audio stream and is decoded at the “Voice Only” device into analog audio so that user can hear it and understand it.

Step 10. The user may then either provide a name e.g. “Call Bill Smith” or a telephone number “Call 925-555-1212”.

Step 11 A phone call is thus placed and a Voice over IP (VOIP) connection is established.

### EXAMPLE 2

### A Data Access Application using a “Voice Only” Device

The same steps outlined in the previous example would be executed to establish a TCP/IP based link with the specific application URL.

In this case because the device type is known to be a “Voice Only” device it will not accept any text or graphical input. The application interface now gets routed through a CPS that provides voice to text, and text to voice translation. Clearly graphics cannot be supporte don this type of device. However most data based applications such as e-mail, SMS, news delivery, stock quotes etc. can be easily supported. Thus the application gracefully scales the features available to a specific mobile access device. The user is only exposed to the features that this mobile device can support.

### EXAMPLE 3

### Access using a PDA Type Device that can Support Graphics

The same steps as before would be followed to establish the TCP/iP link. IN this case however, the CPS/DPO program pair knows that mobile device has graphics capability and will therefore present data in the format supported by the specific device. A device of this sort would also be capable of supporting voice as well as data applications.

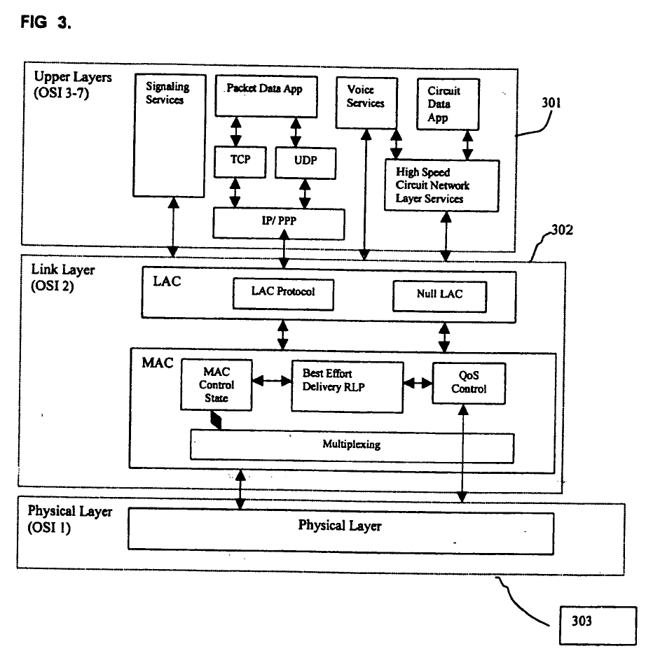

An example of the protocol stack required to support an IS-95 cdma or CDMA 2000 wireless IP network is shown in FIG. 3. The FIG. 3 illustrates the Upper Layer OSI 3-7, the Link Layer OSI 2 and the Physical Layer OSI 1. the abbreviations used in FIG. 3 are as follows:
LAC—Link Access Control
MAC—Medium Access Control
OSI—Open Systems Interconnect
PPP—Point to Point Protocol
QoS—Quality of Service
RLP—Radio Link Protocol
TCP—Transmission Control Protocol
UDP—User Datagram Protocol

Such software stacks are well known. For example see a book by Vijay K. Garg—“IS-95 Cellular/PCS systems Implementation; Prentice-Hall PTR”; 2000. The above book is hereby incorporated herein by reference.

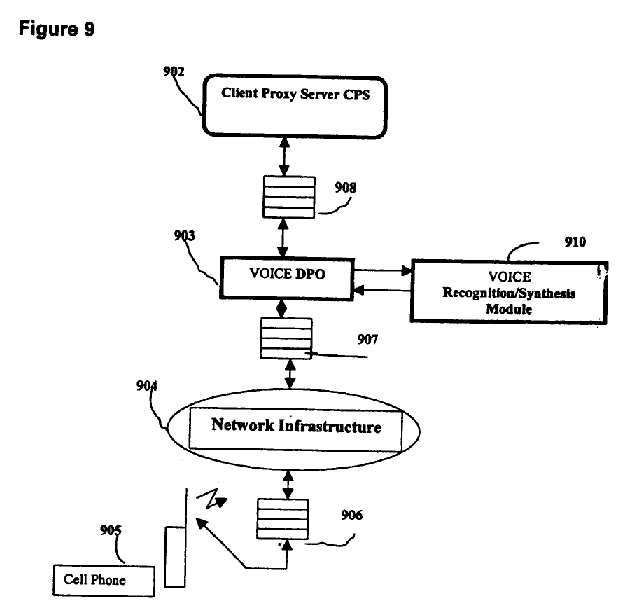

FIG. 9 is a block diagram illustrating as an example of how a mobile device accesses the target application for service. That is FIG. 9 is a representation of the connecting blocks data flow between the Application and the mobile device in use. The example illustrated in FIG. 9 involves a mobile access device in the form of a cell phone 905. The cell phone 905 connects to the wireless IP network and the entire associated network infrastructure 904 and finally to the application server (AS) and the specific CPS/DPO program pair 902,903 associated with this particular mobile device 905. The DPO 903, on the one side, connects to the TCP/IP layer at the Application Server and on the other it connects to the CPS 902 executing on that server.

The CPS 902 interfaces with the target application program 901 and its associated data. The user connects to the network and selects the desired application following the steps shown in FIG. 8. The mobile device in this example is a voice-only cell phone 907 that is designed in accordance with the present invention.

The users voice commands are digitized by the mobile device, packetized and transmitted through the network infrastructure 904 onto the device's DPO 903 as IP-packets via the paths 906 and 907. The physical path 906 is an abstraction of the network infrastructure that is involved in delivering IP-packets to the target application server.

The path 907 represents the TCP/IP buffer queues. The DPO 903 extracts a packet from the buffer 907 and parses the incoming mobile device packet. It extracts all device dependent information and spawns any necessary programs required to support the mobile device e.g. a Voice-recognition/Voice-synthesis program 910 to provide a voice-only user interface. The DPO 903 then maps the IP-packet payload data into a device independent payload and sends it to the CPS 902 for session and presentation layer control through a buffer mechanism 908. The CPS 902 parses this incoming packet payload and decides upon which application 901 it must invoke. It then formats the payload data into a format e.g. a series of XML commands that he application 901 accepts and responds to and sends them to the application via a buffer mechanism represented by 909.

The application 901 will respond to the XML commands with the appropriate response via a buffer mechanism 909. The CPS 902 will then process and translate the payload for processing by the DPO 903. The DPO 903 will process the payload and pass it through any special program e.g. the Voice-recognitionlVoice-synthesis module 910 for device specific processing. In this example the application data is converted from text to voice by the Voice-recognition/Voice-synthesis module 910. The output of this module may then be a compressed bit stream. This bit stream is buffered and packetized into IP packets and sent to the mobile device 905. The ASD in the mobile device extracts the payload from the IP packet stream and transform the extracted bit stream into an audio signal. This process is repeated as many times as required during a user session.

While the invention has been shown and described with respect to preferred embodiments thereof, those skilled in the art will understand that various other changes in form and detail may be made without departing from the spirit and scope of the invention. The scope of this invention is limited only by the appended claims.

What is claimed is:

1. A system including a plurality of portable devices each having at least one input/out device and a central server,
said server including at least one Client Proxy Server (CPS) and a Device Personality Object (DPO) for each portable device, whereby there is a CPS/DPO program pair for each portable device,
a packetizer/de-packetizer at each portable device for generating Internet Protocol (IP) packets from input to said portable device and for generating output from IP packegs provided to said portable device,
a communication network for transmitting IP packets between each portable devices and the associated CPS/DPO pair,
said central server including at least one application program,
each CPS/DPO pair providing an interface between the associated hand held device and said application program,
whereby said hand held devices merely serve as input output devices, transmitting and receiving IP packets to and from the associated CPS/DPO pair, and all computation and data storage relative to said application is done at said central server.

2. A system which includes a plurality of portable devices, said portable devices having device characteristics and at least one input/output device,
each of said portable devices including a packetizer/de-packetizer for packetizing and de-packetizing input to said hand portable devices into IP packets,
a central application server which includes at least one application program and a CPS (Client Proxy Server) for each of said plurality of hand held devices,
a communication network for transmitting IP (Internet Protocol) packets from said portable devices to said server, whereby input to said handheld device is packetized and transmitted to the associated CPS, and data from said CPS is packetized and transmitted to the associated portable device,
said CPS being adapted to abstract device dependencies from said application program and to uniquely map between the device characteristics of said portable devices and said application program.

3. A system including,
a plurality of portable devices,
a central server,
a radio communication network for transmitting standard Internet Protocol (IP) packets between providing radio communication between said portable devices and said central server,
a plurality of applications on said central server,
a Client Proxy Server (CPS) program on said central server which interfaces input and output messages from said protable devices to said applications,
Whereby said protable devices serve as input output devices, communicating with said central server using IP packets and all computations and data storage relative to said applications is done at said central server, and
Whereby said protable devices can be very simple low cost devices that use little power.

4. The system recited in claim 1 where each of said portable devices includes a Software defined Radio (SDR) which transmits IP packets to said AS.

5. The system recited in claim 2 where each of said portable devices includes a Software defined Radio (SDR) which transmits IP packets to said AS.

6. The system recited in claim 3 where each of said portable devices includes a Software defined Radio (SDR) which transmits IP packets to said AS.

7. The system recited in claim 2 where each of said portable devices includes an Application Specific Device Module (ASD) that identifies the particular device to the AS.

8. The system recited in claim 2 where each of said portable devices includes an Application Specific Device Module (ASD) that identifies the particular device to the AS.

9. The system recited in claim 3 where each of said portable devices includes an Application Specific Device Module (ASD) that identifies the particular device to the AS.

10. A method of connecting a plurality of portable devices to an application program located at a central server, each of said portable device having input and output capability, said central server including at least one application program, said portable device not including a browser,
each portable device generating Internet Protocol (IP) packets containing the input received by the associated portable device,
transmitting said IP packets to said device,
de-packetizing said packets at said AS and using the input received by the associated portable device to exercise said application program and to generate output,
packetizing said output into IP packets and transmitting the IP packets containing said output to the associated portable device,
de-packetizing said output at the portable device and presenting said output to a user,
whereby said portable devices communicate with said application program at said central server using IP packets.
